(19) United States
(12) Patent Application Publication
(10) Pub. No.: US 2004/0078810 A1
(43) Pub. Date: Apr. 22, 2004

(54) Method and system for performing actions related to programming in an electronic program guide

(76) Inventors: Monica Marics, Boulder, CO (US); Patricia Somers, Boulder, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 10/165,819

(22) Filed: Jun. 7, 2002

(51) Int. Cl. H04N 7/173; G06F 13/00; H04N 5/445; G06F 3/00

(52) U.S. Cl. 725/43; 725/51; 725/112; 725/113

(57) ABSTRACT

A method and system for performing actions related to programming in an electronic program guide (EPG) are provided. The method includes receiving a signal indicating the selection of a specific program displayed in the EPG and receiving a signal specifying an action command to be applied to the selected program. The method further includes processing the signals to determine an appropriate content window to be displayed corresponding to the action command.

### BACKGROUND OF THE INVENTION

1. Field of the Invention

This invention relates to a method and system for performing actions related to programming in an electronic program guide (EPG).

2. Background Art

To select a program to view, many television viewers simply “channel surf”, or sequentially view each channel, until they find a channel that has a desirable program. However, as the number of available channels continues to grow, channel surfing has become an increasingly inefficient method for viewers to find the type of program they want to watch. Instead, most viewers prefer a more direct method for selecting a program to view and obtaining information regarding the selected program.

Some cable television networks dedicate a specific channel to serve as an electronic program guide. Alternatively, an electronic program guide can be superimposed over a current channel as described, for example, in U.S. Pat. No. 5,635,978 issued to Alten et al. Typically, one standard program guide is provided for all viewers or subscribers to a network. These electronic program guides are usually time-based and are scrolled continuously or periodically. Since only a few channels can be displayed at once, the time for completing one cycle of the channels can be considerable.

With such a wide range of programs offered, individual viewers usually prefer selected subsets of the available programming. To meet this need, customized electronic program guides have been developed in which the on-screen display includes programs from only a specific content category or a list of programs on favorite channels. See, for example, U.S. Pat. No. 5,596,373 issued to White et al., U.S. Pat. No. 5,694,176 issued to Bruette et al., and U.S. Pat. No. 5,758,259 issued to Lawler. Such specialized program guides limit somewhat the amount of information viewers must sift through to select a program. However, current electronic program guides still typically require the viewer to explicitly request more information about a program to aid in their selection decision.

In addition, people increasingly “surf” the Internet and watch television at the same time. Since the Internet contains a vast amount of information on virtually any subject, viewers may wish to see information related to the topic of the particular programming they are watching. In some instances, video programming references a related web site or contact e-mail address through a text display or voice-over. However, viewers may not remember the Internet address correctly and thus fail to ever reach the referenced web site or e-mail address. Therefore, a need exists to allow viewers to more easily and accurately perform such actions for programs of their choosing.

### SUMMARY OF THE INVENTION

It is an object according to the present invention to provide a method and system which allow a user to perform an action on a television or Internet access apparatus based on content in an electronic program guide.

It is a further object according to the present invention to provide a method and system which allow a user to access a web site or e-mail address associated with a selected program in an electronic program guide.

It is another object according to the present invention to provide a method and system which make electronic program guides easier to navigate.

Accordingly, a method for performing actions related to programming in an electronic program guide (EPG) is provided. The method includes receiving a signal indicating the selection of a specific program displayed in the EPG, and receiving a signal specifying an action command to be applied to the selected program. The method further includes processing the signals to determine an appropriate content window to be displayed corresponding to the action command.

In accordance with the present invention, displaying the content window can include providing a browser for displaying a web site related to the selected program, or it can include providing an e-mail client for sending an electronic mail to an address related to the selected program. Displaying the content window can also include displaying information for accessing a stored copy of the selected program, such as the source and cost for accessing the stored copy.

In a preferred embodiment, the method of the present invention further includes receiving a signal specifying a subset of programming to be displayed in the EPG, such as a desired date, time range, or channel of programming, and displaying the desired programming subset. Still further, the method of the present invention can include receiving a signal specifying a user preference for displaying EPG information, such as the desire to display a program description, and displaying the EPG according to the user preference.

In further accordance with the present invention, a method is provided for performing actions related to programming in an EPG. The method includes receiving a signal specifying a subset of programming to be displayed in the EPG and displaying the desired programming subset in the EPG. The method further includes receiving a signal indicating the selection of a specific program displayed in the EPG. Still further, the method includes receiving a signal specifying an action command to be applied to the selected program and displaying a content window corresponding to the action command.

Correspondingly, a system is provided for performing actions related to programming in an EPG. The system includes a viewer input apparatus operable to generate signals indicating the selection of a specific program displayed in the EPG and an action command to be applied to the selected program. A set-top box (STB) in communication with the viewer input apparatus is operable to receive program signals from a programming source, where the program signals include EPG data. The set-top box includes a program receiver to receive the program signals, a viewer input receiver for receiving signals from the viewer input apparatus, and a processor in communication with the program receiver and the viewer input receiver to determine an appropriate content window to be displayed. A display is provided in communication with the set-top box for displaying the EPG and the content window corresponding to the action command.

According to a preferred embodiment of the present invention, the set-top box includes a program database for storing program data to be displayed in the EPG. The set-top box preferably further includes a tuner operable to tune the program receiver to the selected program and a decoder in communication with the viewer input receiver and the processor. The set-top box can also include a personal video recorder (PVR) and a URL decoder in communication with the program receiver. The display can include a television or, alternatively, can include an Internet access apparatus, such as a personal computer or a web tablet. The system further includes a modem in communication with the set-top box or with the Internet access device. The viewer input apparatus can include a remote controller or, alternatively, can include a keyboard in communication with the Internet access apparatus.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a flow diagram outlining the method according to the present invention;

FIG. 2 is a block diagram providing an overview of a preferred embodiment of the system of the present invention; and

FIG. 3 is a block diagram showing a more detailed view of the components of the set-top box of FIG. 2.

### DETAILED DESCRIPTION OF THE PREFERRED EMBODIMENT(S)

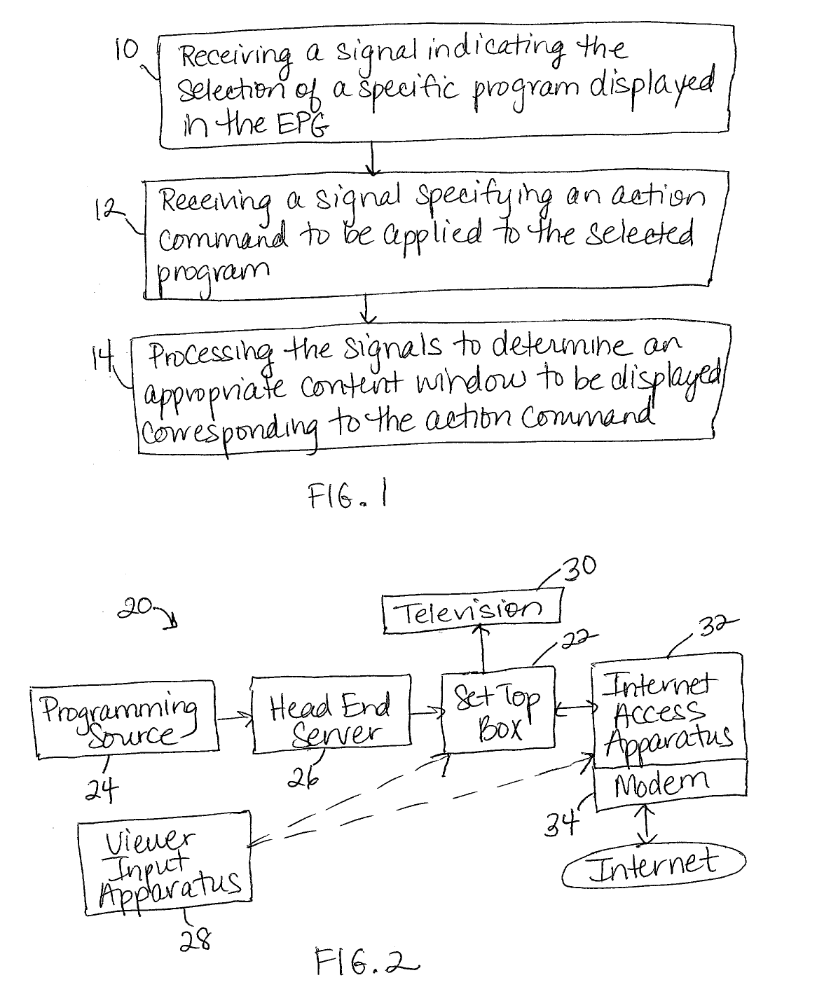

Referring first to FIG. 1, a flow diagram outlining the method according to the present invention of performing actions related to programming in an electronic program guide (EPG) is illustrated. The method includes receiving (10) a signal indicating the selection of a specific program displayed in the EPG and receiving (12) a signal specifying an action command to be applied to the selected program. The method further includes processing (14) the signals to determine an appropriate content window to be displayed corresponding to the action command. As described below, the method of the present invention can also include receiving user preferences for displaying programs in the EPG prior to specifying a selected program.

A preferred embodiment of a system 20 for carrying out the method of the present invention is depicted in the block diagram of FIG. 2. System 20 includes a set-top box 22 that is constructed to receive program signals from a programming source 24, such as a cable television network, via a head-end server 26. Program signals include video signals, audio signals, and program information including EPG data for all channels available on the cable television network. The program signals can be transmitted from programming source 24 to set-top box 22 over a public or private network in analog, digital, or digitally compressed formats via such methods as a television broadcast, analog and digital cable, satellite, Internet, or telephony. However, it is understood that the system and method of the present invention are not dependent upon the particular means of transmission or reception.

Set-top box 22 is responsive to input signals generated by a viewer input apparatus 28, such as a remote controller. Input signals from viewer input apparatus 28 indicate the selection of a specific program displayed in the EPG and an action command to be applied to the selected program. Viewer input apparatus 28 is preferably provided with conventional remote controller function keys, such as power, volume, channel, and 0-9 digit keys among others, and functions in a conventional manner, transmitting signals via infrared, radio frequency, or other signaling technology. Of course, another type of viewer input apparatus 28, such as a computer keyboard, could be used to practice the present invention.

Still referring to FIG. 2, one or more displays are provided in communication with set-top box 22 for displaying the selected television program, the EPG, and the content window corresponding to the action command. The display can include a television 30 and additionally can include an Internet access apparatus 32, such as a personal computer, web tablet, PDA, cellular telephone, or Internet appliance. Set-top box 22 is operable to receive program signals from programming source 24 and to broadcast a display signal representing the selected program to television 30. The system further includes a modem 34 in communication with Internet access apparatus 32 for establishing a connection to the Internet. This connection can be initiated by the user or can be maintained continuously, termed an “always on” Internet connection.

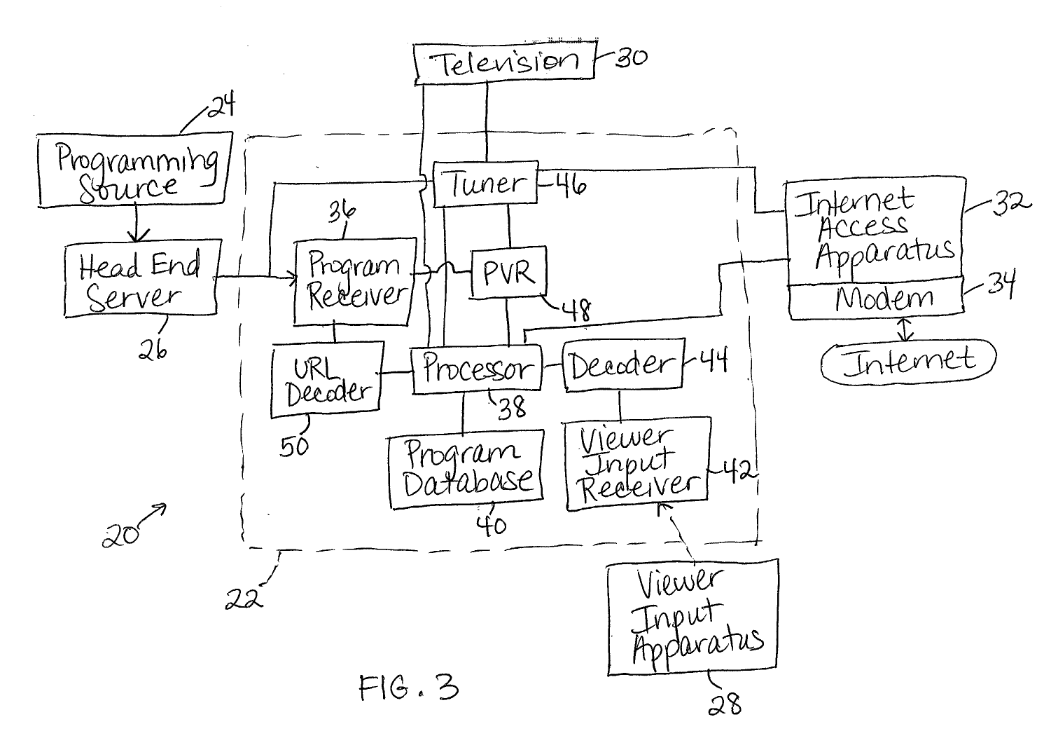

Referring now to FIG. 3, a more detailed view of the components of set-top box 22 is shown. Set-top box 22 includes a program receiver 36 which operates to receive program signals from programming source 24 via head-end server 26 for all channels to which a particular viewer has access. Set-top box 22 further includes a processor 38 in communication with program receiver 36 and a program database 40. Under the control of processor 38, program information received by program receiver 36 is stored in program database 40 for display in the EPG. The program information is preferably downloaded from head-end server 26 to set-top box 22 using a prearranged schedule, for example, at 2 a.m. each morning for the next day's programming.

As shown in FIG. 3, set-top box 22 is also provided with a viewer input receiver 42 for receiving input signals from viewer input apparatus 28 indicative of an action command and a decoder 44 for converting the input signals to digital information for delivery to processor 38. In this way, processor 38 can determine an appropriate content window to be displayed based upon the action command. In a preferred embodiment, viewer input receiver 42 is an infrared receiver. In addition, set-top box 22 is provided with a tuner 46 for tuning program receiver 36 to the selected program. Set-top box 22 may also optionally contain a modem (not shown) for connection to the Internet, and a personal video recorder (PVR) 48. Of course, as an alternative to the separate housing of set-top box 22, system components could be included in another signal reception or processing device, such as a satellite receiver, a television receiver, or a VCR.

In operation, the EPG is displayed on television 30 or Internet access apparatus 32 based on EPG data received in the program signals and stored in program database 40. According to the present invention, the user then selects a program in the EPG and selects an action command to apply to that program. The program and action command may be selected via buttons on viewer input apparatus 28, via an on-screen menu, or via a keyboard in communication with Internet access apparatus 32. If the user makes selections via Internet access apparatus 32, appropriate instructions are sent to set-top box 22. A content window is then displayed which corresponds to the action command.

In accordance with the present invention, displaying the content window can include providing a browser for displaying a web site related to the selected program or providing an e-mail client for sending an electronic mail to an address related to the selected program. Set-top box 22 or Internet access apparatus 32 retrieves the relevant Internet address from the program signal and then displays a browser or e-mail client with that address. More particularly, uniform resource locators (URLs), which designate particular Internet addresses, can be embedded in a program signal by the broadcaster or content owner. The Internet addresses can be embedded in the vertical blanking interval (VBI) of the program signal or, alternatively, in the horizontal portion of the program signal, the close captioning of the program signal, an audio channel, a digital data field, or in any other part of the program signal in such a manner as not to interfere with the displayed video and audio.

Set-top box 22 is provided in communication with a URL decoder 50 (FIG. 3) which is operable to extract the one or more embedded Internet addresses and provide the addresses to processor 38. URL decoder 50 may either be a stand-alone unit, integrated within set-top box 22 as depicted herein, or implemented as a card provided in Internet access apparatus 32. The details of the construction of such a decoder are well known in the art and need not be described in further specificity herein. Upon receiving the action command, Internet access apparatus 32 establishes a communication link with the web site through transmission of a signal containing the selected Internet address. Processor 38 and/or Internet access apparatus 32 includes platform independent software, such as JAVA, to present web pages and e-mail clients to the user.

According to the present invention, an action command can also initiate the display of a content window which includes information for viewing a stored copy of the selected program, such as the source and cost for accessing the stored copy. To view a stored copy of the selected program, set-top box 22 or Internet access apparatus 32 should be able to access a database of locations of stored copies. This may include a record on set-top box 22 of copies stored therein within PVR 48, a database in the network of copies made available by the cable television provider, or a database of copies made available by other PVR owners. Set-top box 22 or Internet access apparatus 32 determines whether a stored copy is available, displays related information such as source and cost in a content window, and allows the user select from the available stored copies.

As is known in the art, an EPG displays a grid of programming for a time period and set of channels. In a preferred embodiment, the method of the present invention further includes receiving a signal specifying a particular subset of programming to be displayed in the EPG, such as a desired date, time range, or channels of programming, and displaying the desired programming subset. In this way, the user can specify criteria instructing the EPG grid to jump immediately to the corresponding programming content, obviating the need to scroll through the entire EPG to find the information of interest to the user and thus making the EPG easier to navigate. The user could select these criteria from on-screen menus via viewer input apparatus 28 or alternatively enter them via a keyboard. The corresponding data is retrieved from the program database in the STB and is displayed on the television screen. For example, if the user specifies that they want to view programs for tomorrow starting at 8:00 PM on all premium channels, the information for that time and set of channels would be displayed in the EPG on television 30 or Internet access apparatus 32.

Still further, the method of the present invention can include receiving a signal specifying a user preference for displaying EPG information, such as the desire to display or hide a program description, such as the name of the program episode, and displaying the EPG according to the user preference. Again, this preference can be selected from an on-screen menu via viewer input apparatus 28. The user preference is then stored in program database 40 to become the new default setting for display of the EPG.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for performing actions related to programming in an electronic program guide (EPG), the method comprising:
receiving a signal indicating the selection of a specific program displayed in the EPG;
receiving a signal specifying an action command to be applied to the selected program; and
processing the signals to determine an appropriate content window to be displayed corresponding to the action command.

2. The method according to claim 1, wherein displaying the content window includes providing a browser for displaying a web site related to the selected program.

3. The method according to claim 1, wherein displaying the content window includes providing an e-mail client for sending an electronic mail to an address related to the selected program.

4. The method according to claim 1, wherein displaying the content window includes displaying information for accessing a stored copy of the selected program.

5. The method according to claim 4, wherein displaying information includes displaying source and cost for accessing the stored copy.

6. The method according to claim 1, further comprising receiving a signal specifying a subset of programming to be displayed in the EPG, and displaying the desired programming subset.

7. The method according to claim 6, wherein receiving the signal specifying the subset of programming includes specifying a desired date and time range of programming.

8. The method according to claim 6, wherein receiving the signal specifying the subset of programming includes specifying at least one desired channel of programming.

9. The method according to claim 1, further comprising receiving a signal specifying a user preference for displaying EPG information, and displaying the EPG according to the user preference.

10. The method according to claim 9, wherein receiving the signal specifying a user preference for displaying EPG information includes specifying the desire to display a program description.

11. A method for performing actions related to programming in an electronic program guide (EPG), the method comprising:
receiving a signal specifying a subset of programming to be displayed in the EPG;
displaying the desired programming subset in the EPG;
receiving a signal indicating the selection of a specific program displayed in the EPG;
receiving a signal specifying an action command to be applied to the selected program; and
displaying a content window corresponding to the action command.

12. A system for performing actions related to programming in an electronic program guide (EPG), the system comprising:
a viewer input apparatus operable to generate signals indicating the selection of a specific program displayed in the EPG and an action command to be applied to the selected program;
a set-top box in communication with the viewer input apparatus and operable to receive program signals from a programming source, the program signals including EPG data, wherein the set-top box includes a program receiver to receive the program signals, a viewer input receiver for receiving signals from the viewer input apparatus, and a processor in communication with the program receiver and the viewer input receiver to determine an appropriate content window to be displayed; and
a display in communication with the set-top box for displaying the EPG and the content window corresponding to the action command.

13. The system according to claim 12, wherein the set-top box includes a program database for storing program data to be displayed in the EPG.

14. The system according to claim 12, further including a modem in communication with the set-top box.

15. The system according to claim 12, wherein the viewer input apparatus includes a remote controller.

16. The system according to claim 12, wherein the display includes a television.

17. The system according to claim 12, wherein the display includes an Internet access apparatus.

18. The system according to claim 17, wherein the Internet access apparatus includes a personal computer.

19. The system according to claim 17, wherein the Internet access apparatus includes a web tablet.

20. The system according to claim 17, further including a modem in communication with the Internet access apparatus.

21. The system according to claim 17, wherein the viewer input apparatus includes a keyboard in communication with the Internet access apparatus.

22. The system according to claim 12, wherein the set-top box further includes a tuner operable to tune the program receiver to the selected program.

23. The system according to claim 12, further comprising a decoder in communication with the viewer input receiver and the processor.

24. The system according to claim 12, further comprising a personal video recorder in communication with the program receiver.

25. The system according to claim 12, further comprising a URL decoder in communication with the program receiver.
